(19) United States
(12) Patent Application Publication
(10) Pub. No.: US 2002/0091940 A1
(43) Pub. Date: Jul. 11, 2002

(54) E-mail user behavior modification system and mechanism for computer virus avoidance

(76) Inventors: Christopher Michael Welborn, Davis, CA (US); Kimberly Joyce Welborn, Davis, CA (US)

Correspondence Address: CHRISTOPHER MICHAEL WELBORN, 331 SANDPIPER DRIVE, DAVIS, CA, 95616, US

(21) Appl. No.: 09/755,509

(22) Filed: Jan. 5, 2001

(51) Int. Cl. G06F 11/30

(52) U.S. Cl. 713/201

(57) ABSTRACT

Nearly all computer viruses require an action by a computer user to infect and spread. The key is to educate users not to open e-mail attachments that might carry computer viruses. The key is behavior modification, as education is not sufficient. Effective behavior modification must have a means to reinforce the change and to measure how widespread the change is in a population. The invention is used to reinforce and measure the change in user behavior. The invention sends an e-mail with an attachment to e-mail users and creates a list of all users that open the attachment. The user is sent an e-mail with an attachment that looks similar to attachments that contain computer viruses. If the attachment is opened, an e-mail is sent to a specific e-mail address. This e-mail address collects all of the e-mail from users who have not changed behavior and need additional education or management attention.

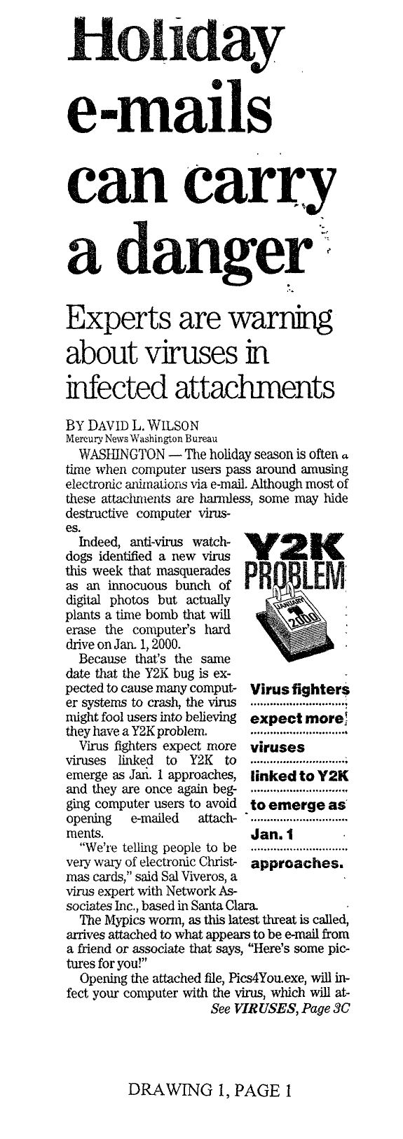

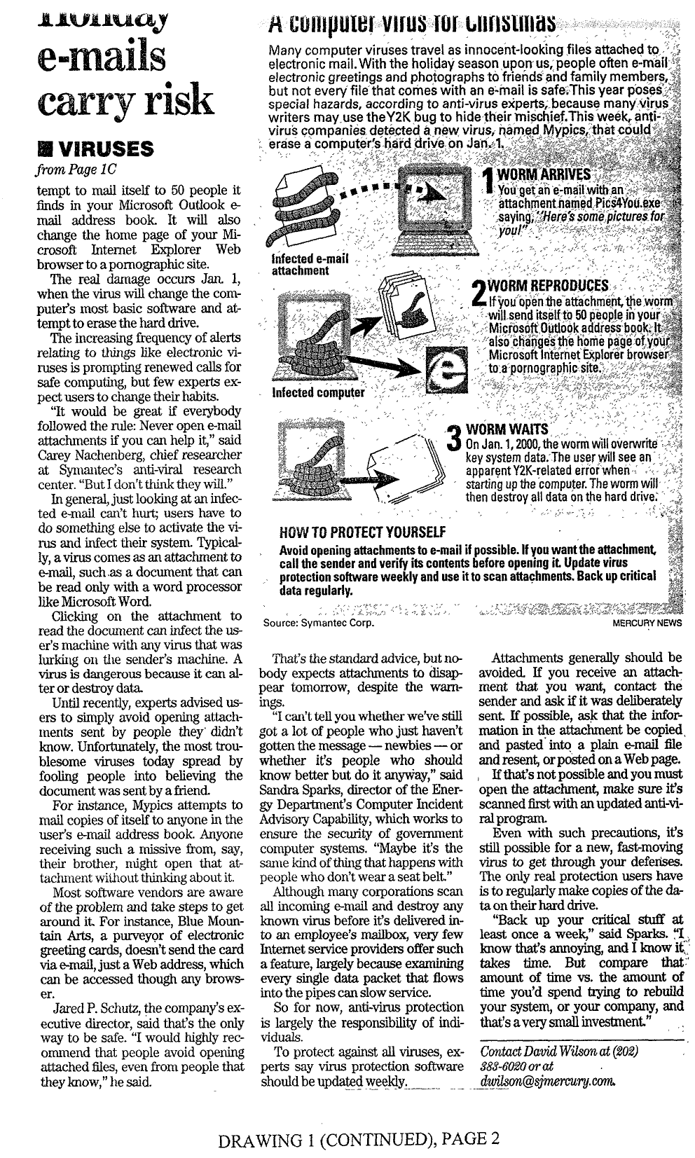

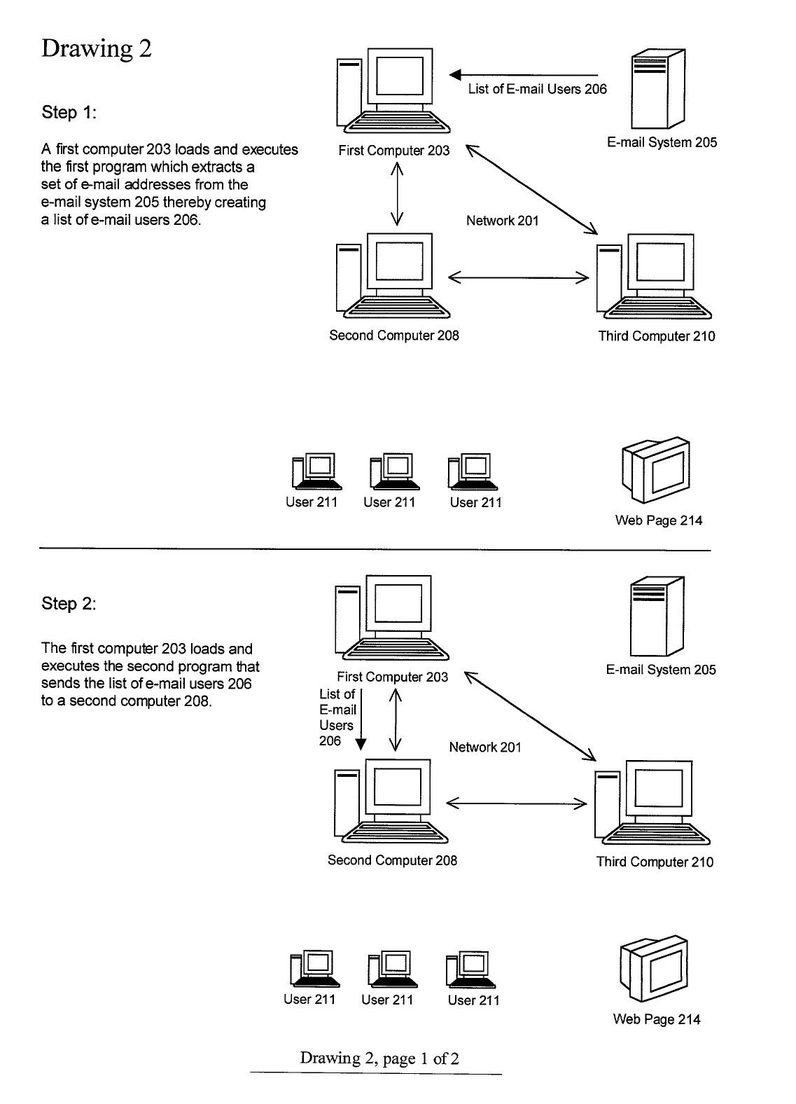

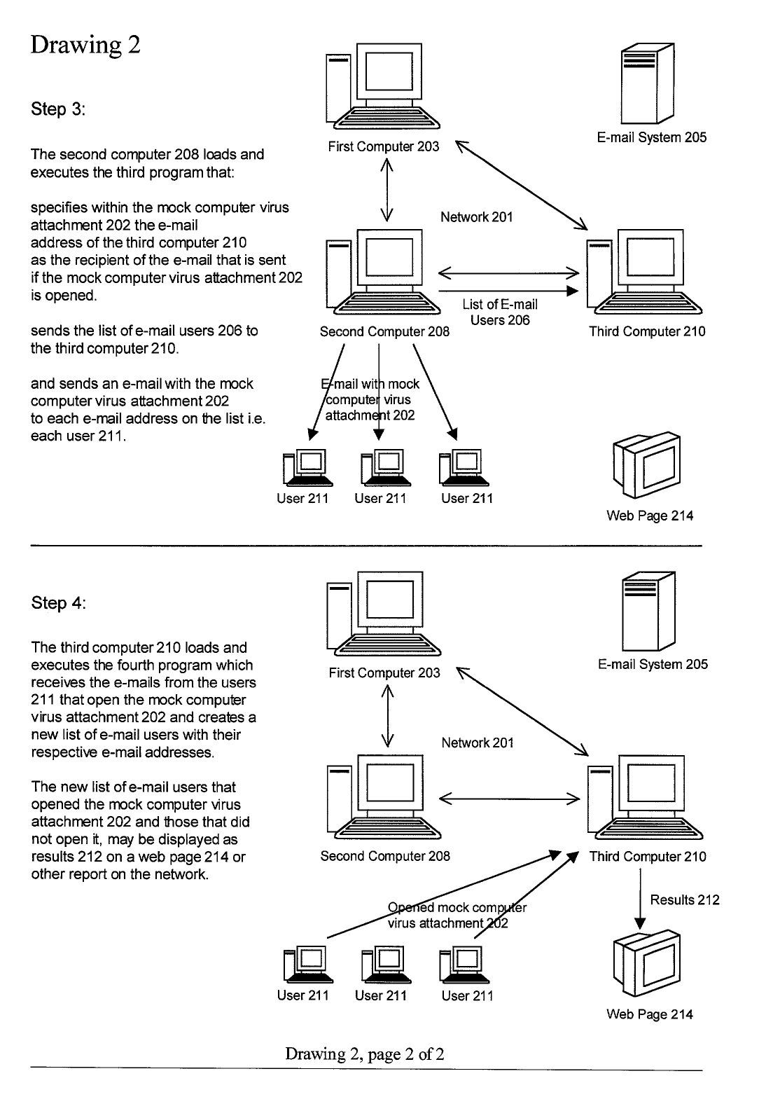

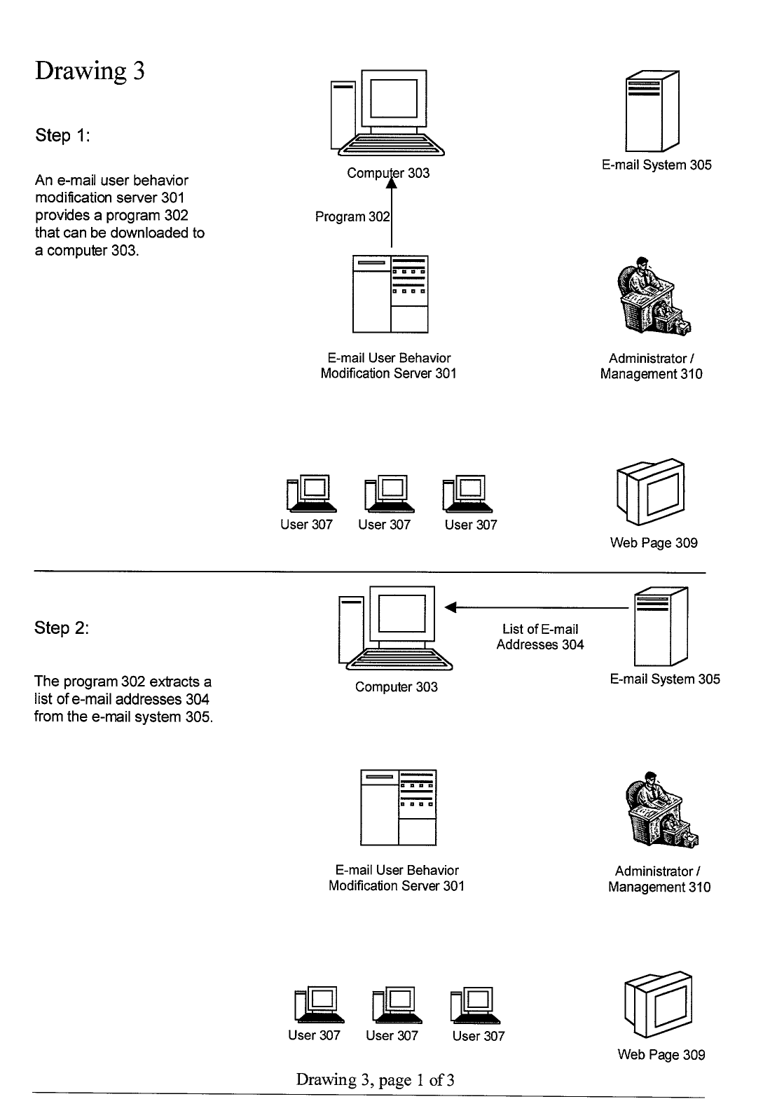

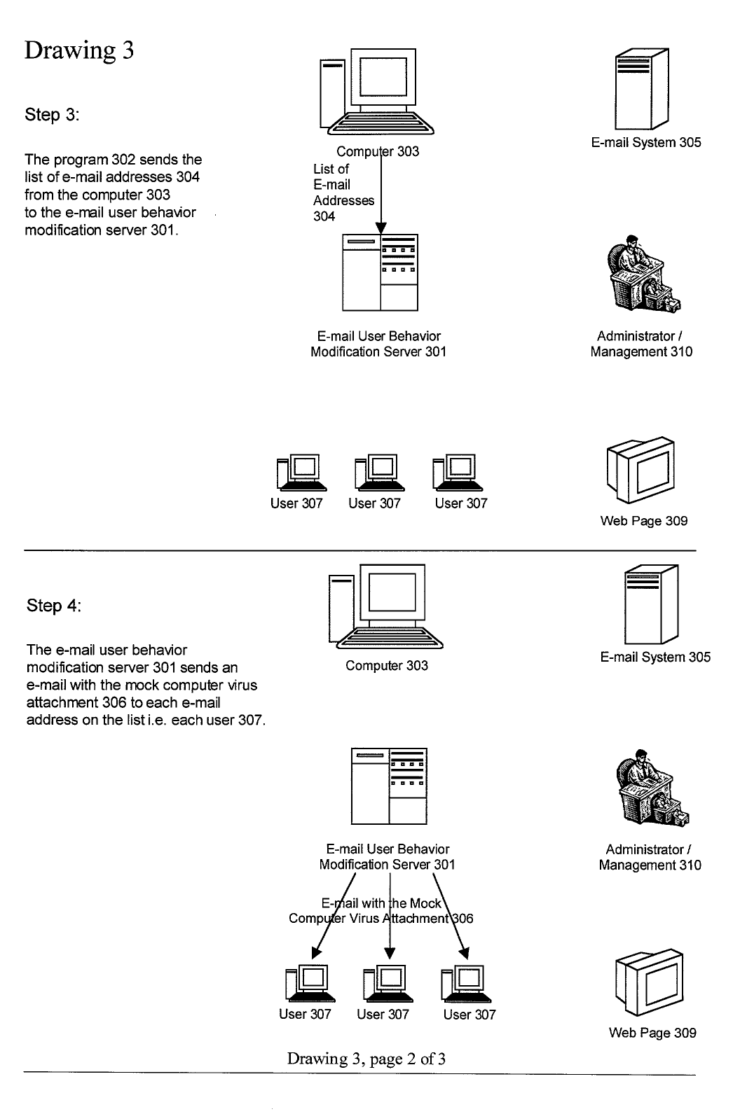

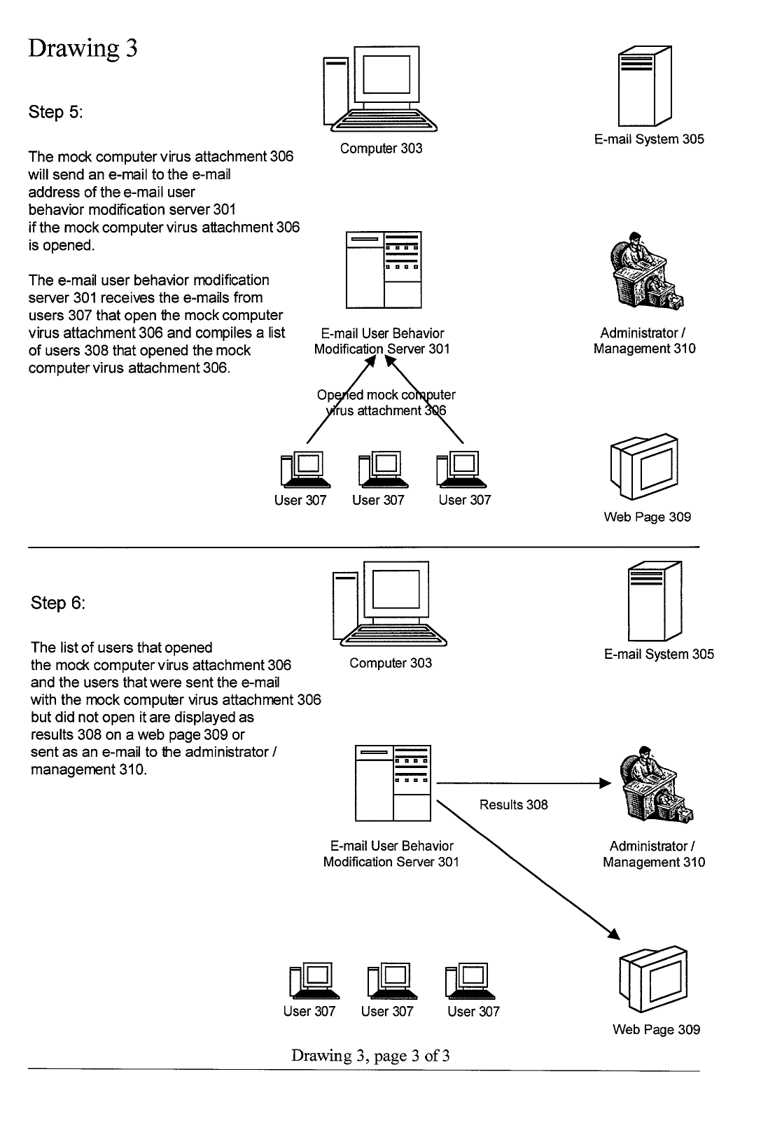

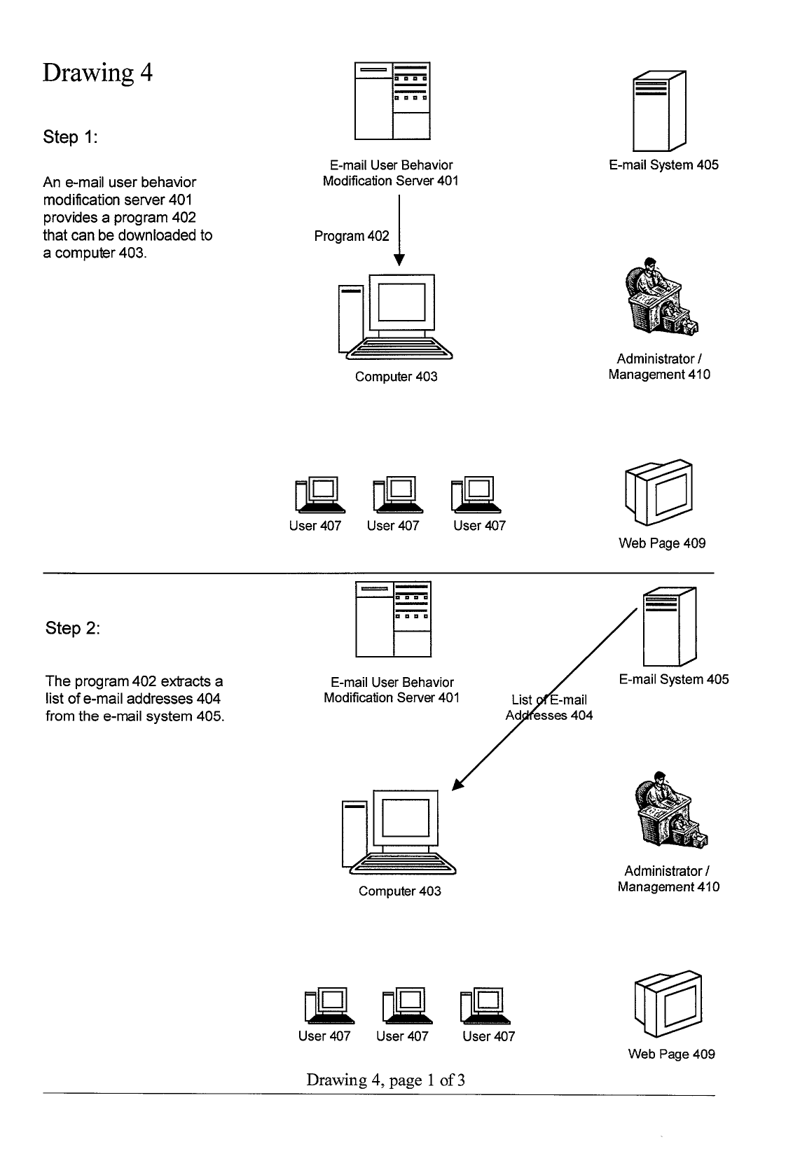

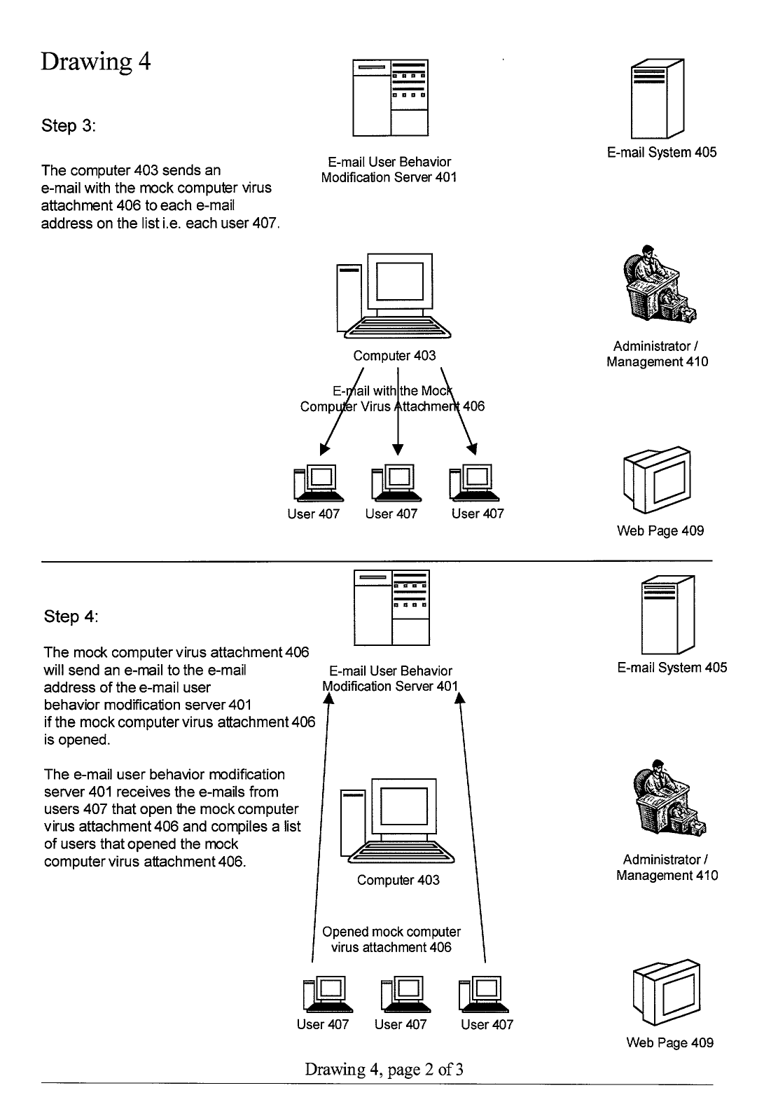

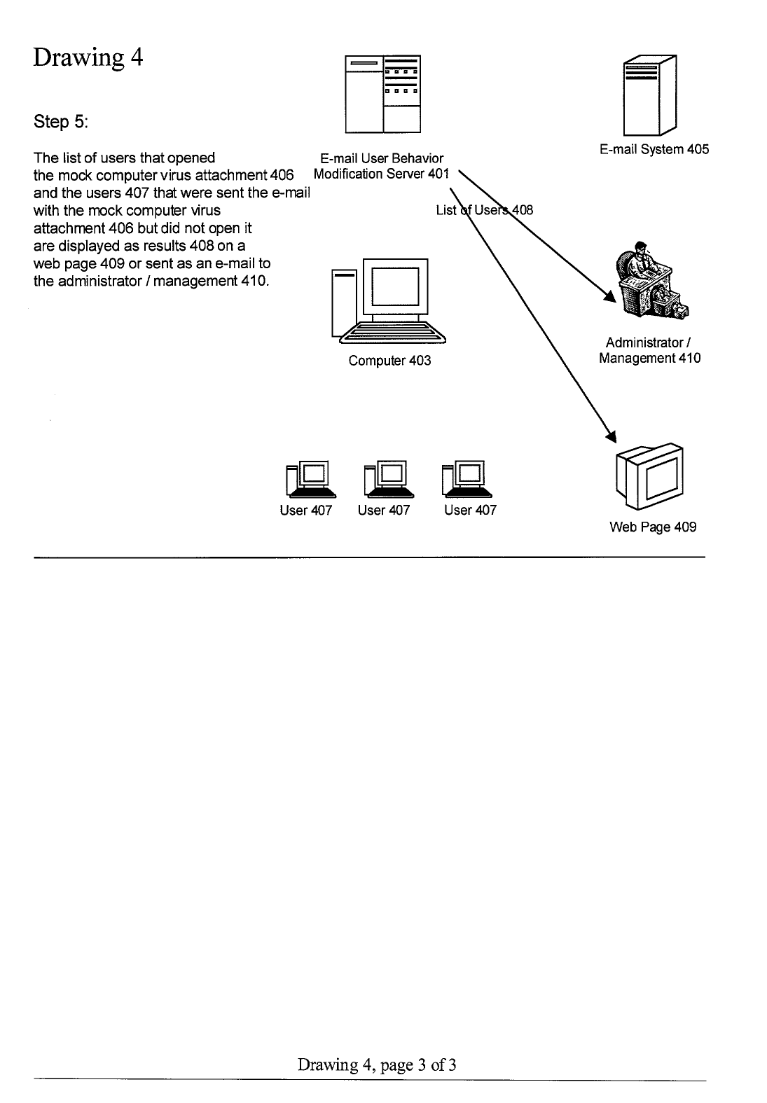

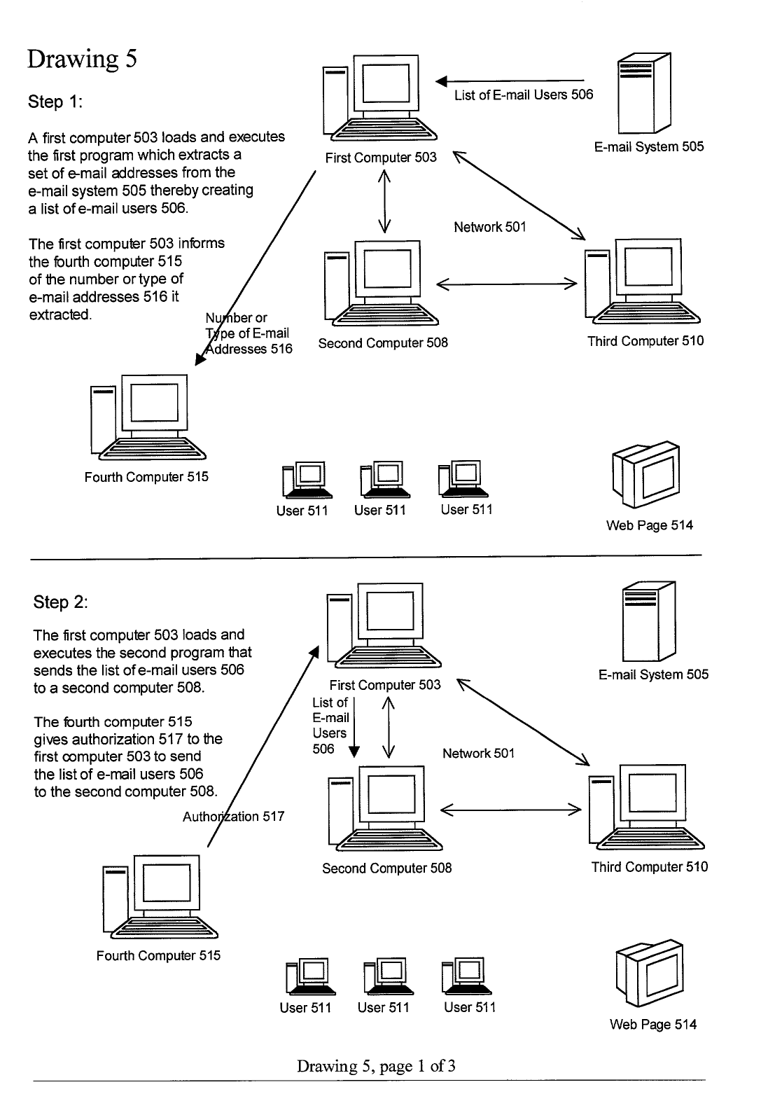

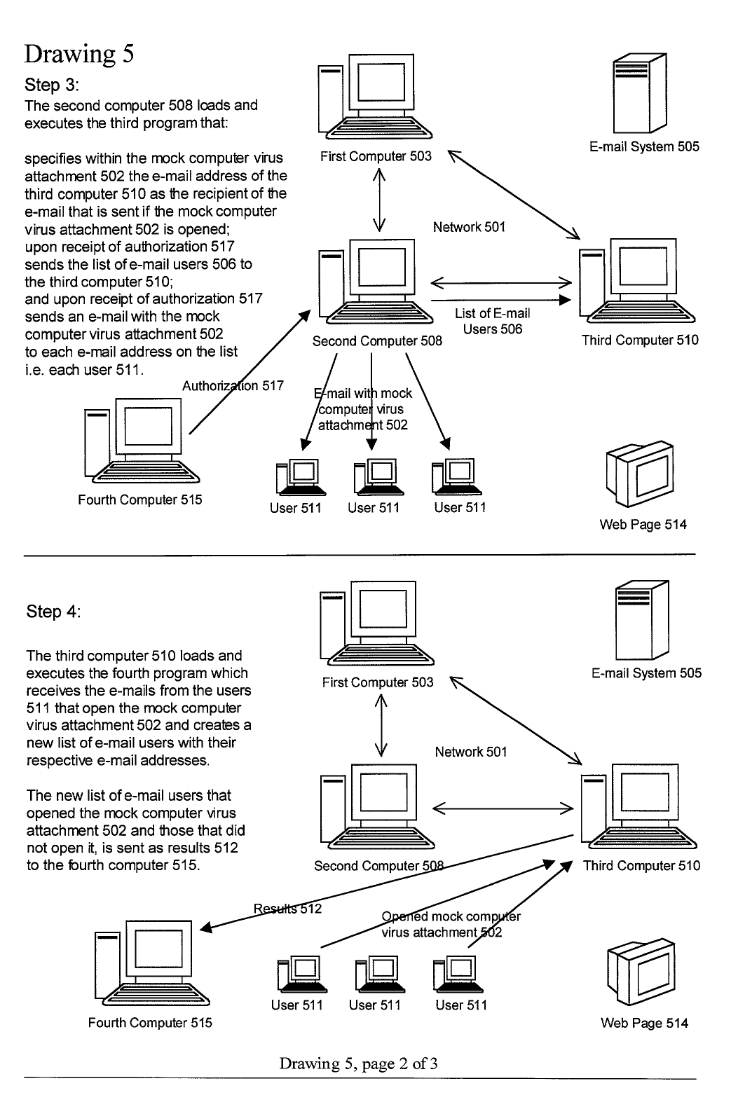

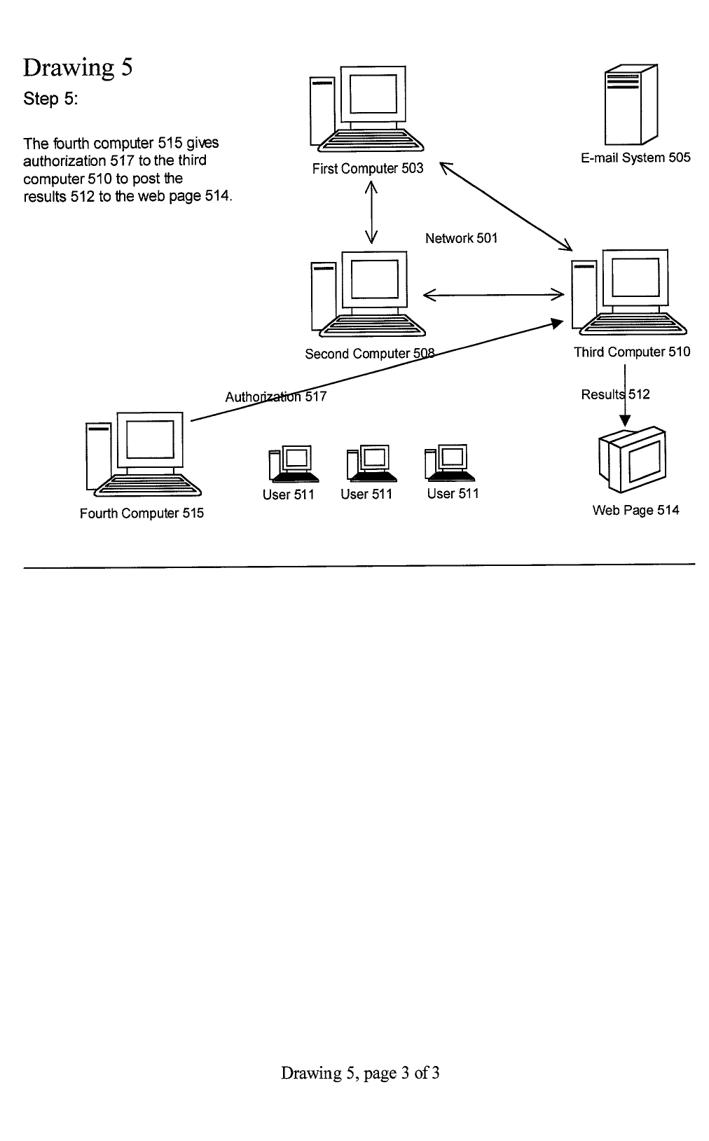

### CROSS-REFERENCE TO RELATED APPLICATIONS

application Ser. No.: 09/470,058

Filing Date: Dec. 22, 1999

Group Art Unit: 2787

Title of Invention: Computer Virus Avoidance System and Mechanism

Name of Inventors: Kimberly Joyce Welborn and Christopher Michael Welborn

Application Number: unknown

Filing Date: Nov. 30, 2000

Group Art Unit: unknown

Title of Invention: Computer Virus Avoidance System and Mechanism Using Website

Name of Inventors: Christopher Michael Welborn and Kimberly Joyce Welborn

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to a computer system that aids in the behavior modification of computer users who unknowingly and innocently spread computer viruses, specifically by teaching computer users to avoid computer viruses with the use of mock computer viruses and feedback measurements.

The Battle Against Computer Viruses:

Computer viruses pose significant threats to computer systems. Viruses cause loss of data, destroy computer hardware, create negative impacts to computer networks and systems, and disrupt business, government, and personal affairs. In the battle against computer viruses, an entire industry was created to develop and sell “anti-virus” software to detect, remove, and insulate computers from viruses. Numerous patents have been granted to achieve these same goals. Examples of corporations within the anti-virus industry are Symantec and Network Associates. Currently, the control of viruses is dependent upon companies such as these to identify characteristics of viruses, write anti-virus software to detect viruses when encountered, and insulate computers from viruses. However, viruses are created faster than anti-virus software, and anti-virus software cannot always prevent outbreaks of virus infections. It is desirable to avoid the negative impacts of virus infections without reliance on software that needs to continually adapt to detect new specific viruses.

What are Computer Viruses?

A computer virus is a program that invades computer host systems. Once inside a host system, the virus may replicate and create copies of itself. The virus may also cause damage to the host system. Viral programs can damage host systems by using the host file system to overwrite data in host systems, or over-write data stored in networks attached to host systems, or create numerous other disruptions or damage. In addition to damaging the host system, the virus may perpetuate itself by transmitting replicated copies to other computer systems. Most computer viruses use e-mail systems to transmit the replicated copies to other computer systems. By transmitting replicated copies of itself to other computer systems, the virus invades new host systems and continues the life-cycle of viral replication, host system damage, and transmission of duplicate virus programs.

How Computer Users Spread Viruses:

E-mail systems alone cannot activate viral programs within host systems. Viral programs require activation by computer users, and therefore viral programs are sent as file attachments to e-mail messages. The creators of the viral programs rely on computer users to open the infected file attachments. The viral programs activate when users open infected attached files. The term “open” means the user starts the program in the attachment or starts a program associated with the attachment. In Microsoft Windows and NT operating systems, data files are named in a two part format of the form xxxxxxxx.yyy, where the “.” separates the user given name, “xxxxxxxx”, from the extension, “yyy”. The operating system uses the extension, “yyy”, to select how the data file is to be treated when opened. For example if the extension is “exe”, then the operating system treats the data file as an executable program and passes control to it when opened. Or, if the extension is “doc”, the operating system associates the document with the Microsoft Word program, loads the Microsoft Word program, and passes control to the Microsoft Word program with the data file as an input file.

What are Viral Infected E-Mail Attachments?

Viral infected e-mail attachments are of two types: 1) programs that execute when opened or 2) “macros” that execute when data files are opened as documents in other programs such as Microsoft Word. A macro is a program that is written in a language specific to another program such as Microsoft Word. Macros are used to automate sets of “user actions”. Examples of macro “user actions” are the ability to open and write data files, and to send e-mail messages with attachments to recipients in the users' e-mail directories. Viral macros may use the previously described user actions and other functions to send replicated copies of itself as attachments to other e-mail users. The infected attachments may cause damage to data in the host system or to data in a network that is attached to the host system.

Life-Cycle of Computer Viruses:

The key to life or the goal of viruses is to replicate and transmit copies of itself to other computer systems. There are viral programs that can access the computer users' e-mail directory and the computer users' e-mail folders. This access allows the virus to send additional replicated viral attachments to associates of the user. The viral e-mail messages appear to originate from someone the recipient knows and trusts, when in fact the virus sends the e-mail message itself. The unsuspecting recipient opens the infected files due to the mistaken belief that the file is virus-free merely because the e-mail was sent from a familiar e-mail address. The opened and activated virus file repeats its cycle, and the virus succeeds in its continuous spread to other computer systems.

What is Being Done?

Anti-virus companies such as Symantec and Network Associates attempt to stop viruses with the detection, removal, and insulation of computer viruses. Additionally, software creators of e-mail systems attempt to curb the spread of viruses by building features into e-mail programs that attempt to prevent the opening of viral attachments. For example, Microsoft Corporation added capabilities to recent releases of Outlook and Exchange e-mail programs that makes opening attachments with executable programs a two-step process. In the Microsoft Outlook email program, an attachment to an e-mail appears as an icon in the body of the e-mail. The file name appears as text in the icon. The user “opens” the attachment by double clicking on the icon. The first step consists of a warning message that is displayed when the icon is double-clicked. The user must perform a second action to actually open the file. Consistent with this, recent releases of Microsoft Word and Excel have a similar two-step document opening process if there is a macro in the document. First the user is warned that there is a macro in the document. The second step requires the user to choose to not open the document, disable the macro and open the document, or open the document with an active macro. In spite of these virus avoidance measures, computer users continue to open attachments with viruses, which in turn harms their systems, and sends replicated viral copies to other unsuspecting computer systems. An article written by David L. Wilson and published in the Dec. 4, 1999 edition of the San Jose Mercury News is included as background information on how computer viruses damage, replicate and spread.

### BRIEF SUMMARY OF THE INVENTION

The dangerous computer virus phenomenon cannot be neutralized solely by the use of software programs that detect and remove computer viruses, or by functions within e-mail programs that warn against opening potentially harmful files and attachments. Nearly all computer viruses require action by computer users in order for the viruses to infect and spread. Therefore computer users must change their behavior to stop viruses. Our invention is a tool that teaches computer users to avoid computer viruses with the use of mock computer viruses. The invention can aid, test, and reinforce behavior changes. The invention can also measure the effectiveness of behavior change in an organization or e-mail population by collecting and analyzing feedback measurements.

### BRIEF DESCRIPTION OF THE SEVERAL VIEWS OF THE DRAWING

Drawing 1 is an article written by David L. Wilson and published in the Dec. 4, 1999 edition of the San Jose Mercury News. It is included as background information on how computer viruses damage, replicate and spread. The article demonstrates that attempts are made by the mass media to educate computer users to avoid computer viruses. Despite the widespread information available to users on how to avoid computer viruses, the advice is left unheeded and the viruses continue to damage, replicate, and spread.

Drawing 2 shows a networked computer system in accordance with the first preferred embodiment of the invention.

Drawing 3 depicts a networked computer system in accordance with the second preferred embodiment of the invention.

Drawing 4 illustrates a networked computer system in accordance with the modified second preferred embodiment of the invention.

Drawing 5 reflects a networked computer system in accordance with the third preferred embodiment of the invention.

### DETAILED DESCRIPTION OF THE INVENTION

Computer Users Spread Computer Viruses:

Nearly all computer viruses require action by computer users for the viruses to infect and spread. The key to controlling viruses is to educate users not to open file attachments that might carry viruses. Education about how to avoid computer viruses is similar to education about how to avoid incurable human viral diseases. For example, in some cases of human disease, there are human behaviors that can eliminate or minimize exposure to infectious disease. Computer viruses are similar in that behavior modification on the part of computer users can greatly eliminate or minimize exposure to computer viruses. However, education alone is an ineffective tool to stopping viruses. There are many widely published writings and documents, such as the San Jose Mercury News article, that warn of the danger of opening computer viral attachments yet many people continue to open infectious attachments. Effective behavior modification must have a means to reinforce the change, and to measure how widespread the change is in a population.

Biological immune systems respond to viral attacks by creating antibodies that prevent the spread of the virus. These antibodies remain in the immune system to protect against further attacks by the virus. Vaccines expose the immune system to viral analogs that cause the creation of antibodies without significant harm. The viral analogs are usually created from the original virus where the destructive elements are attenuated or removed. An organization can create computer virus antibodies by changing the behavior of the e-mail users so that they can keep viruses from infecting the computers of the organization. The disclosed invention uses mock computer viruses to change the behavior of the organization's e-mail users so that they will be aware of the nature of computer viruses and will not open real viruses and thus prevent the destruction that computer viruses can cause and prevent their spread to others. Like biological immune systems, the effects of antibodies diminish over time and “booster” shots are needed to keep the immune system effective. The disclosed invention may be used to keep an organization's e-mail users on alert for computer viruses that may attack them and the organization.

Changing Human Behavior is the Key to Conquering Computer Viruses:

In general, most computer users do not need to send executable programs as attachments or documents with macros to other e-mail users. One behavior change is that a user should not send executable programs or documents with macros unless absolutely necessary. If it is necessary to send such attachments, the sender needs to communicate to the recipient to expect specific attachments. The second, and most important, behavior change is that a user should not open an attachment that is an executable program or a document with a macro unless there is specific knowledge that the attachment is safe to open. The third behavior change is that a user should inform their information services staff if they receive an e-mail attachment that appears to contain a computer virus. This last behavior provides early warning of new computer viruses, and allows companies such as Symantec and Network Associates to update their anti-virus software detection programs before the virus becomes widespread.

How Behavior Changes can be Made, Measured and Tracked:

Our invention tests, reinforces, and measures the changes in computer user behavior in regards to viral attachments, or attachments that may carry viruses. The invention:

1. generates a list of e-mail users from an e-mail directory;

2. sends to each user an e-mail with a mock computer virus attachment which when opened by a user will send an e-mail to a specified e-mail address;

3. compiles a list of e-mail users who opened the mock computer virus attachment;

4. identifies e-mail users who opened the mock computer virus attachment and whose behavior must be modified to prevent triggering real computer viruses that are attached to e-mail messages;

5. identifies users that were sent an e-mail with a mock computer virus attachment but did not open the attachment and should be rewarded to reinforce the positive behavior.

Three embodiments of this system will be described. The term e-mail includes but is not limited to messaging systems for local area networks, wide area networks, Intranets, Internet, and Extranets, wireless messaging systems, and other means of message transmission. Examples of commercial e-mail systems are Microsoft Outlook, IBM Lotus Notes, Microsoft Hotmail, and Eudora by Qualcomm. The term computer includes but is not limited to personal computers, workstations, mid-range computers, main frame computers, distributed computers, portable computers, personal digital assistants, cell phones, and other means of executing programs and processing messages. The term network includes but is not limited to local area networks, wide area networks, Intranets, Internet, and Extranets, wireless analog and wireless digital networks, satellite communications networks and other means of interconnecting communication among computers.

The embodiments include programs that may be written in a wide variety of programming languages such as Java or Visual Basic or C++. The mock computer virus attachment contains a program that is activated by a user who “opens” the attachment by selecting the attachment for execution. This is the mechanism most widely used by computer viruses to activate the computer virus program. The mock computer virus does not damage the user's computer but sends an e-mail to a specified e-mail address as an indication that the mock computer virus was opened. This e-mail includes the e-mail address of the sender and thus, identifies the e-mail address of the user that opened the mock computer virus attachment.

A first embodiment (Drawing 2) consists of a system that provides four programs for three computers connected to a computer network 201 with an e-mail system 205 and a mock computer virus attachment 202. A first computer 203 downloads and executes the first program that extracts a set of e-mail addresses from the e-mail system 205 thereby creating a list of e-mail users 206. The first program may permit an administrator to edit or augment the list of e-mail users 206. The administrator is local to the organization that is using the system and is usually the e-mail system administrator or someone responsible for the security of the system against computer virus attacks. The first computer 203 loads and executes the second program that sends the list of e-mail users 206 to a second computer 208. It should be noted that the first program and second program could have been combined into one program that executes in two phases. This description separated these phases into separate programs for clarity. The second computer 208 loads and executes the third program that: specifies within the mock computer virus attachment 202 the e-mail address of the third computer 210 as the recipient of the e-mail that is sent if the mock computer virus attachment 202 is opened; sends the list of e-mail users 206 to the third computer 210; and sends an e-mail with the mock computer virus attachment 202 to each e-mail address on the list i.e. each user 211. The third computer 210 loads and executes the fourth program that receives the e-mails from the users that open the mock computer virus attachment 202 and creates a new list of e-mail users with their respective e-mail addresses. The fourth program in the third computer 210 may compare the list of e-mail users 206 to which the mock computer virus attachment 202 was sent with the new list of e-mail users that opened the mock computer virus attachment 202 to determine which e-mail addresses had not opened the mock computer virus attachment 202. The new list of e-mail users that opened the mock computer virus attachment 202 and those that did not open it may be displayed as results 212 on a web page 214 or other report on the network. Those skilled in the art recognize that the functions of these three computers may be combined and implemented in fewer than the three computers described.

A second embodiment (Drawing 3) is an Internet-based service where an e-mail user behavior modification server 301 provides a program 302 that can be downloaded to a computer 303. The program extracts a list of e-mail addresses 304 from the e-mail system 305. A local administrator may edit or augment the list of e-mail addresses 304. The program 302 sends the list of e-mail addresses 304 from the computer 303 to the e-mail user behavior modification server 301. The e-mail user behavior modification server 301 sends an e-mail with the mock computer virus attachment 306 to each e-mail address on the list i.e. each user 307. The mock computer virus attachment 306 will send an e-mail to the e-mail address of the e-mail user behavior modification server 301 if the attachment is opened. The e-mail user behavior modification server 301 receives the e-mails from users 307 that open the mock computer virus attachment 306 and compiles a list of users that opened the mock computer virus attachment 306. The list of users that opened the mock computer virus attachment 306 and the users 307 that were sent the e-mail with the mock computer virus attachment 306 but did not open it are displayed as results 308 on a web page 309 or sent as an e-mail to the administrator/management 310 or as an e-mail with a URL to a web page with this information. The difference of the list of e-mail addresses 304 to which the e-mail with the mock computer virus attachment 306 was sent to the list of users that opened the mock computer virus attachment 306 provides the list of e-mail users that have not opened the mock computer virus attachment 306. These are the e-mail users that should be rewarded for safe e-mail behavior.

A modified second embodiment (Drawing 4) is an Internet-based service where the program 402 downloaded from the e-mail user behavior modification server 401 to a computer 403 extracts a list of e-mail addresses 404 from the e-mail system directory 405 and sends an email with the mock computer virus attachment 406 to each e-mail address, i.e. each user 407, on the list of e-mail addresses 404. The local administrator may edit or augment the list of e-mail addresses 404 to which the e-mail with the mock computer virus attachment 406 is sent. The mock computer virus attachment 406 will send an e-mail to the e-mail address of the e-mail user behavior modification server 402 when the attachment is opened. The list of users that opened the mock computer virus attachment 406 and the users 407 that were sent the e-mail with the mock computer virus attachment 406 but did not open it are displayed as results 408 on a web page 409 or sent as an e-mail to the administrator/management 410 or as an e-mail with a URL to a web page with this information. The difference of the list of e-mail addresses 404 to which the e-mail with the mock computer virus attachment 406 was sent to the list of users that opened the mock computer virus attachment 406 provides the list of e-mail users that have not opened the mock computer virus attachment 406. These are the e-mail users that should be rewarded for safe e-mail behavior.

A further modified second embodiment is an Internet-based service as described above except the mock virus attachment 406 will send an e-mail to the e-mail address of the administrator's computer 403 or other local e-mail address for creation of the list of users that opened the mock virus attachment 406.

A third embodiment (Drawing 5) is an Internet-based service where the service has mechanisms to measure and control the use of the e-mail user behavior system. These mechanisms are used for billing the using organizations for the service. The first embodiment described the operation of three independent computers. The third embodiment adds a fourth computer 515 to control the operation of the three independent computers. The control mechanism must be secure since billing may be based on usage or some other value-based measure. The program executing in the first computer 503 can determine the number or type of e-mail addresses 516 extracted from the e-mail directory and can send this information to the fourth computer 515 before receiving an authorization 517 to send the list of e-mail users 506 to the second computer 508. The first computer 503 can change the e-mail address selection process independently, or as authorized by the fourth computer 515, or as directed by the fourth computer 515. The information in the fourth computer 515 that describes the number, type, or e-mail selection process can be used for billing for use of the e-mail user behavior modification system. The program executing in the second computer 508 is designed to require an authorization 517 from the fourth computer 515 to send an e-mail with the mock computer virus attachment 502. The authorization 517 can take the form of an encoded request message sent by the second computer 508 to the fourth computer 515, which then responds with an encoded authorization message. The authorization message response to the second computer 508 is decoded by the program and then the second computer 508 can send the e-mail with the mock computer virus attachment 502. The fourth computer 515 can determine from the authorization messages the number of e-mails with mock computer virus attachments 502 that were sent. In addition, the second computer 508 can encode the type of mock virus sent, the type of e-mail addresses used, or other value-based measurements to inform the fourth computer 515 of the operation to be authorized. The information of the number or type of e-mail with mock computer virus attachments 502 captured by the fourth computer 515 can then be used to bill for usage of the e-mail user behavior modification system. The mock computer virus attachment 502 sent by the second computer 508 may be modified or changed by the program in the second computer 508 or changed under the control of the fourth computer 515. The program in the second computer 508 can be designed to require an authorization 517 from the fourth computer 515 as to the type of mock computer virus attachment 502 used or can require that the fourth computer 515 provide the mock computer virus attachment 502. The billing can be based on the type or number of different mock computer virus attachments 502 sent by the second computer 515. The program in the third computer 510 can be designed to collect the number and type of email messages sent by users that opened the mock computer virus attachment 502. The third computer 510 can send this information to the fourth computer 515 for authorization 517 before permitting viewing of the results 512. The number or type of e-mail messages can be used for billing purposes. The results 512 of e-mail users that opened the mock computer virus attachment 502 and/or those that had not yet opened the mock computer virus attachment 502 has value. The program in the third computer 510 can be designed to collect the number of web page 514 views of the results 512 or e-mail reports sent with the results 512 and send this information to the fourth computer 515 before permitting additional access to the results 512. This information can be used for billing.

The second embodiment is based on a service and has several points where the e-mail user behavior modification server performs specific functions including the creation of the list of email addresses, creating the e-mail with the mock virus attachment, the sending of the e-mail, and the reporting of the e-mail address of users that open the mock virus attachment. These functions can be monitored and controlled as done by the fourth computer referenced in the third embodiment.

All of the embodiments can be modified to allow the administrator or other member of the user's organization to create their own custom e-mail and/or custom mock computer virus attachment as well as their own educational responses in the event the e-mail is or is not opened.

The e-mail user behavior modification system tests the population of e-mail users with an e-mail that has a mock virus attachment that looks like a real computer virus. The e-mail users that open the attachment might very well open a real computer virus and place an organization at risk. Identification of these users so that their behavior can be modified is of value to an organization. For billing purposes, mechanisms can be embodied to control and monitor the use of the e-mail user behavior modification system.

What is claimed:

1. An e-mail user behavior modification system for computer virus avoidance, an e-mail system with users each with an e-mail address and a first, second, and third computer in a computer network, wherein the e-mail user behavior modification system provides:
means for a first computer to select a set of e-mail addresses from an e-mail directory;
means for the first computer to transmit the set of e-mail addresses to a second computer in the computer network;
means for the second computer to send an e-mail with a mock computer virus attachment to a user with an e-mail address in the set of e-mail addresses;
means for the mock computer virus attachment when opened by a user, to send an e-mail to the e-mail address of a third computer indicating that the mock virus attachment was opened by the user;
means for the third computer to compile a list of users with e-mail addresses that opened the mock computer virus attachment.

2. The e-mail user behavior modification system of claim 1 wherein the computer network is the Internet.

3. The e-mail user behavior modification system of claim 1 wherein the first computer and second computer are the same computer.

4. The e-mail user behavior modification system of claim 1 wherein the first computer and third computer are the same computer.

5. The e-mail user behavior modification system of claim 1 wherein the second computer and third computer are the same computer.

6. The e-mail user behavior modification system of claim 1 wherein the first computer, second computer and third computer are the same computer.

7. The e-mail user behavior modification system of claim 1 wherein the list of users with email addresses that opened the mock computer virus attachment is accessible as a web page or sent as an e-mail.

8. The e-mail user behavior modification system of claim 1 wherein there is a fourth computer in the computer network and the second computer receives authorization from the fourth computer to send an e-mail with a mock computer virus attachment to an email address.

9. The e-mail user behavior modification system of claim 1 wherein the first computer has a means to determine the number or type of e-mail addresses in the set of e-mail addresses and sends this information to a fourth computer.

10. The e-mail user behavior modification system of claim 9 wherein the number or type of email addresses in the set of e-mail addresses is used to determine the billing for use of the e-mail user behavior modification system.

11. The e-mail user behavior modification system of claim 1 wherein the second computer has a means to determine the number or type of e-mail with mock computer virus attachments sent to e-mail addresses.

12. The e-mail user behavior modification system of claim 11 wherein the number or type of e-mail sent to e-mail addresses is used to determine the billing for use of the e-mail user behavior modification system.

13. The e-mail user behavior modification system of claim 1 wherein the third computer has a means to determine the number or type of e-mail received from e-mail addresses.

14. The e-mail user behavior modification system of claim 13 wherein the number or type of e-mail received from e-mail addresses is used to determine the billing for use of the e-mail user behavior modification system.

15. The e-mail user behavior modification system of claim 1 wherein the fourth computer has a means to determine the number or type of e-mail with mock computer virus attachments authorized to be sent by the second computer to e-mail addresses.

16. The e-mail user behavior modification system of claim 15 wherein the number or type of e-mail with mock computer virus attachments authorized to be sent to e-mail addresses is used to determine the billing for use of the e-mail user behavior modification system.

17. The e-mail user behavior modification system of claim 7 wherein there is a means to determine the number or type of accesses to the list of users at e-mail addresses that opened the mock computer virus attachment.

18. The e-mail user behavior modification system of claim 17 wherein number or type of accesses to the list of users at e-mail addresses that opened the mock computer virus attachment is used to determine the billing for use of the e-mail user behavior modification system.

19. The e-mail user behavior modification system of claim 1 wherein the list or number of users with e-mail addresses who did not open the mock computer virus attachment is determined by waiting a time delay and then comparing the list of e-mail addresses sent the e-mail with the mock virus attachment with the list of e-mail addresses that opened the mock virus attachment.

20. The e-mail user behavior modification system of claim 19 wherein the list or number of users with e-mail address who did not open the mock computer virus attachment is used to determine the billing for use of the e-mail user behavior modification system.

21. The e-mail user behavior modification system of claim 1 wherein the fourth computer can change the mock virus attachment sent by the second computer.

22. The e-mail user behavior modification system of claim 1 wherein the second computer can change the mock virus attachment.

23. The e-mail user behavior modification system of claim 1 wherein the second computer can change the mock virus attachment with authorization from the fourth computer.

24. The e-mail user behavior modification system of claims 21, 22, or 23 wherein the change in mock virus attachment is used to determine the billing for use of the e-mail user behavior modification system.

25. The e-mail user behavior modification system of claim 1 wherein the fourth computer can change the e-mail address selection means used by the first computer to select a different set of e-mail addresses.

26. The e-mail user behavior modification system of claim 1 wherein the first computer can change the e-mail address selection means to select a different set of e-mail addresses.

27. The e-mail user behavior modification system of claim 1 wherein the fourth computer can authorize the first computer to change the e-mail address selection means to select a different set of e-mail addresses.

28. The e-mail user behavior modification system of claims 25, 26, or 27 wherein the change in address selection means is used to determine the billing for use of the e-mail user behavior modification system.

29. The e-mail user behavior modification system of claim 1 wherein the list of users with email addresses that opened the mock computer virus attachment is sent as an e-mail.

30. The e-mail user behavior modification system of claim 1 wherein the list of users with email addresses that opened the mock computer virus attachment is sent as an e-mail with a URL to a web page containing the list.

31. The e-mail user behavior modification system of claims 7, 29, or 30 wherein the access to the list of users with e-mail addresses that opened the mock virus attachment is used to determine the billing for use of the e-mail user behavior modification system.

32. An e-mail user behavior modification system for computer virus avoidance, an e-mail system with e-mail users, each with an e-mail address, and a first, second, and third computer in a computer network, wherein the e-mail user behavior modification system provides to the computers a first, second, third, and fourth program and an e-mail with a mock computer virus which are used as follows:
the first program executes in a first computer to select a set of e-mail addresses from the email directory of the e-mail system;
the second program executes in the first computer to transmit the set of e-mail addresses to a second computer in the computer network;
the third program executes in the second computer to send the e-mail with a mock computer virus attachment to a user with an e-mail address in the set of e-mail addresses;
the mock computer virus attachment is a program that when opened by the user, sends an email to the e-mail address of a third computer indicating that the user opened the mock virus attachment;
the fourth program executes in the third computer to compile a list of users with e-mail addresses that opened the mock computer virus attachment.

33. An e-mail user behavior modification system for computer virus avoidance wherein a mock virus is sent to a set of e-mail users with e-mail addresses and a list of those e-mail users that open the mock virus is created.

34. An e-mail user behavior modification system for computer virus avoidance wherein a list of e-mail addresses is extracted from an e-mail system, an e-mail with a mock virus attachment is sent to an e-mail address in the list of e-mail addresses, and if the user with the e-mail address opens the mock virus attachment, the e-mail address is added to a list of e-mail users that opened the mock virus.

35. An e-mail user behavior modification system for computer virus avoidance wherein a network server provides a program to a computer which when executed extracts an e-mail addresses from the directory of an e-mail server and sends an e-mail with a mock virus attachment to the e-mail address.

36. The e-mail user behavior modification system of claim 35 wherein the network is the Internet.

37. An e-mail user behavior modification system for computer virus avoidance wherein a computer with an e-mail address receives an e-mail message from an opened mock virus email attachment and compiles a list of e-mail address that opened the mock virus.

38. An e-mail user behavior modification system for computer virus avoidance wherein a network server provides a program to a computer which when executed extracts a list of e-mail addresses from the directory of an e-mail server and sends an e-mail with a mock virus attachment to an e-mail address in the list.

39. The e-mail user behavior modification system of claim 38 wherein the network is the Internet.

40. An e-mail user behavior modification system for computer virus avoidance wherein a network server provides a mock virus e-mail attachment which when opened sends an email to a specified e-mail address.

41. The e-mail user behavior modification system of claim 40 wherein the network is the Internet.

42. An e-mail user behavior modification system for computer virus avoidance wherein a network server provides a program that sends a mock virus e-mail attachment to an e-mail address.

43. The e-mail user behavior modification system of claim 42 wherein the network is the Internet.

44. An e-mail user behavior modification system for computer virus avoidance wherein a network server provides a program for receiving an e-mail sent by an opened mock virus e-mail attachment and adding the sending e-mail address to a list of e-mail users that opened the mock virus e-mail attachment.

45. The e-mail user behavior modification system of claim 44 wherein the network is the Internet.

46. An e-mail user behavior modification system for computer virus avoidance wherein a network server provides a list of e-mail users that opened a mock virus e-mail attachment.

47. The e-mail user behavior modification system of claim 46 wherein the network is the Internet.

48. An e-mail user behavior modification system for computer virus avoidance wherein a network server provides a list of e-mail users that were sent a mock virus e-mail attachment but had not opened the mock virus e-mail attachment.

49. The e-mail user behavior modification system of claim 48 wherein the network is the Internet.
